(19) United States
(12) Patent Application Publication
(10) Pub. No.: US 2010/0184887 A1
(43) Pub. Date: Jul. 22, 2010

(54) HYBRID NANOPARTICLES

(75) Inventors: Monica Fernandez Gonzalez, Frankenthal (DE); Richard Riggs, Mannheim (DE); Simon Schambony, Ludwigshafen (DE); Ruediger Sens, Ludwigshafen (DE); Wolfgang Best, Freinsheim (DE); James Reuben Brown, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/667,054

(22) PCT Filed: Jun. 30, 2008
(86) PCT No.: PCT/EP2008/058380

§ 371 Date: Dec. 29, 2009

(30) Foreign Application Priority Data
Jul. 2, 2007 (EP) 07111504.2

(51) Int. Cl. C08K 5/3432; C07F 3/06; C07F 7/21; C07F 7/28; B32B 5/00; C08K 5/54; C08K 5/16

(52) U.S. Cl. 524/99; 546/6; 556/10; 556/55; 428/402; 524/188; 524/208; 977/773

(57) ABSTRACT

Particles obtainable by the reaction of compounds which can form inorganic nanoparticles with organic molecules which comprise functional groups, and the use of these particles for the finishing of inanimate organic polymers, in particular for stabilization against the effect of UV radiation. Liquid formulations which comprise such particles, and also methods for the preparation of the particles and their liquid formulations. Powders which are obtainable from the abovementioned liquid formulations and also liquid formulations which are obtainable by redispersing the powders. Use of nanoparticles with organic light-absorbing compounds attached to the surfaces thereof for stabilizing polymers against the effect of light, free radicals or heat.

The present invention relates to particles obtainable by the reaction of compounds which can form inorganic nanoparticles with organic molecules which comprise functional groups, and to the use of these particles for the finishing of inanimate organic polymers, in particular for stabilization against the effect of UV radiation. Furthermore, the invention relates to liquid formulations which comprise such particles, and also to methods for the preparation of the particles and their liquid formulations. The present invention comprises powders which are obtainable from the abovementioned liquid formulations and also liquid formulations which are obtainable by redispersing the powders.

Further embodiments of the present invention are to be found in the claims, the description and the examples. It goes without saying that the features of the subject matter according to the invention specified above and still to be explained below can be used not only in the combination specifically given in each case, but also in other combinations, without departing from the scope of the invention. The embodiments of the present invention in which all of the features have the preferred or very preferred meanings are preferred or very preferred.

The preparation of surface-modified nanoscale ceramic powders is known from WO 93/21127. The unmodified ceramic powder is dispersed here in water and/or an organic solvent in the presence of a low molecular weight organic compound which possesses a group which can react and/or interact with groups present on the surface of the powder particles. Examples of the low molecular weight organic compounds are particular mono- and polycarboxylic acids, mono- and polyamines, β-dicarbonyl compounds, organoalkoxysilanes, or modified alkoxides. Surface modification with these low molecular weight organic compounds serves to control the agglomeration of the nanoscale particles.

EP 1 205 177 A2 and EP 1 205 178 A2 describe conjugates which can be used for the preparation of dermatological and cosmetic compositions. The conjugates comprise an inorganic pigment and an active ingredient based on organic compounds which are bonded covalently to the inorganic pigment via a spacer group. The preparation of the conjugates takes place through the bonding of the active ingredient to a preformed inorganic pigment via a spacer group.

WO 2006/099952 describes metal oxide particles provided with a shell based on at least one cross-linkable chromophore. The metal oxide particles are initially charged and then provided with the shell comprising cross-linkable chromophores.

WO 2007/017587 and WO 2007/017586 describe mixtures comprising nanoparticles based on metal derivatives and organic compounds which comprise a carboxyl or sulfo group for use in cosmetic sunscreen formulations. The organic compounds are attached covalently to the nanoparticles via the carboxyl or sulfo group. The mixtures are prepared with the aid of specific alkoxy compounds which already comprise the covalently attached organic compounds.

WO 2005/120440 A1 describes particles comprising an inorganic network and organic compounds bonded covalently to the network via a spacer group, the organic compounds being present in the interior of the particles as a result of copolymerization in the course of preparation. The presence of organic molecules in the interior of an inorganic network can have an adverse effect on the performance properties of these particles if, for example, an interaction between the organic molecules and the particle environment is desired.

In the prior art methods mentioned, the preparation of the modified particles often takes place either by the surface modification of particles present, or by the reaction of already modified compounds. In one case one is restricted to existing particle sizes, and in the other case it is necessary first to prepare modified compounds. Both procedures, however, restrict the means of preparing modified particles.

Furthermore, during the finishing of inanimate organic polymers with functional additives, for example with UV-absorbers, the problem often arises that the functional additives leave the polymer matrix over the course of time, for example by migrating to the surface of the polymer (migration). Furthermore, there is the need to increase the stability (life span) of functional additives in inanimate organic polymers.

The object of the present invention was therefore to provide modified particles which are based on a simple and controlled preparation without the use of preformed particles or premodified compounds. It was a further object of the invention to find further and improved preparation methods which permit efficient access to migration-stable functional additives with increased stability.

These and other objects are achieved, as is evident from the disclosure of the present invention, by the various embodiments of the method according to the invention, which are described below.

It has been found that, surprisingly, these objects are achieved by particles P which are obtainable by the reaction of compounds V which can form inorganic nanoparticles X with organic molecules M which comprise functional groups Z, where the molecules M and the compounds V are present together during the formation process of the particles P.

Within the scope of this invention, expressions of the form Cₐ-C_{b} designate chemical compounds or substituents with a certain number of carbon atoms. The number of carbon atoms can be selected from the entire range from a to b, including a and b, a is at least 1 and b is always greater than a. Further specification of the chemical compounds or of the substituents is made by expressions of the form Cₐ-C_{b}—V. V here is a chemical compound class or substituent class, for example alkyl compounds or alkyl substituents.

Halogen is fluorine, chlorine, bromine or iodine, preferably fluorine, chlorine or bromine, particularly preferably fluorine or chlorine.

Specifically, the collective terms specified for the various substituents have the following meaning:

C₁-C₂₀-Alkyl: straight-chain or branched hydrocarbon radicals having up to 20 carbon atoms, for example C₁-C₁₀-alkyl or C₁₁-C₂₀-alkyl, preferably C₁-C₁₀-alkyl, for example C₁-C₃-alkyl, such as methyl, ethyl, propyl, isopropyl, or C₄-C₆-alkyl, n-butyl, sec-butyl, tert-butyl, 1,1-dimethylethyl, pentyl, 2-methylbutyl, 1,1-dimethylpropyl, 1,2-dimethylpropyl, 2,2-dimethylpropyl, 1-ethylpropyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-trimethylpropyl, 1-ethyl-1-methylpropyl, 1-ethyl-2-methylpropyl, or C₇-C₁₀-alkyl, such as heptyl, octyl, 2-ethylhexyl, 2,4,4-trimethylpentyl, 1,1,3,3-tetramethylbutyl, nonyl or decyl, and isomers thereof.

C₁-C₂₀-Alkylcarbonyl: a straight-chain or branched alkyl group having 1 to 20 carbon atoms (as specified above) which is attached via a carbonyl group (—CO—), preferably C₁-C₂₀-alkylcarbonyl, such as, for example, formyl, acetyl, n- or isopropionyl, n-, iso-, sec- or tert-butanoyl, n-iso-, sec- or tert-pentanoyl, n- or iso-nonanoyl, n-dodecanoyl.

Aryl: a mono- to trinuclear aromatic ring system comprising 6 to 14 carbon ring members, e.g. phenyl, naphthyl or anthracenyl, preferably a mono- to dinuclear, particularly preferably a mononuclear, aromatic ring system.

Aryloxy is a mono- to trinuclear aromatic ring system (as specified above) which is attached via an oxygen atom (—O—), preferably a mono- to dinuclear, particularly preferably a mononuclear, aromatic ring system.

Arylalkyl is a mono- to trinuclear aromatic ring system (as specified above) which is attached via a C₁-C₂₀-alkylene group, preferably a mono- to dinuclear, particularly preferably a mononuclear, aromatic ring system.

C₁-C₂₀-Alkylene: straight-chain or branched hydrocarbon radicals having 2 to 20 carbon atoms, for example C₂-C₁₀-alkylene or C₁₁-C₂₀-alkylene, preferably C₂-C₁₀-alkylene, in particular methylene, dimethylene, trimethylene, tetramethylene, pentamethylene or hexamethylene.

Heterocycles: five- to twelve-membered, preferably five- to nine-membered, particularly preferably five to six-membered ring systems having oxygen atoms, nitrogen atoms and/or sulfur atoms, if appropriate two or more rings, such as furyl, thiophenyl, pyrryl, pyridyl, indolyl, benzoxazolyl, dioxolyl, dioxyl, benzimidazolyl, benzothiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

C₁-C₂₀-Alkoxy is a straight-chain or branched alkyl group having 1 to 20 carbon atoms (as specified above) which are attached via an oxygen atom (—O—), for example C₁-C₁₀-alkoxy or C₁₁-C₂₀-alkoxy, preferably C₁-C₁₀-alkyloxy, particularly preferably C₁-C₃-alkoxy, such as, for example, methoxy, ethoxy, propoxy.

Heteroatoms are preferably oxygen, nitrogen, sulfur or phosphorus. Within the context of this invention, the term “solvent” is also used by way of representation for diluents. The dissolved compounds are present either in molecularly dissolved form, suspended form, dispersed form or emulsified form in the solvent or in contact with the solvent. Solvents are of course also to be understood as meaning mixtures of solvents.

“Liquid formulations” of the particles P according to the invention are solutions, dispersions, emulsions or suspensions of the particles P.

Within the context of this application, “nanoparticles” are understood as meaning particles which have a particle size of from 1 nm to 1000 nm.

To determine the particle size of nanoparticles and of the particles P, the person skilled in the art has available to him a series of different methods which depend on the composition of the particles and can sometimes produce differing results with regard to the particle size. For example, the particle size can be determined by measurements with the help of a transmission electron microscope (TEM), dynamic light scattering (DLS) or measurements of the UV absorption wavelength. Particle sizes are determined within the context of the present application, if possible, with the help of the measurements of a transmission electron microscope (TEM). For an ideally spherical shape of the nanoparticles, the particle size would correspond to the particle diameter. Of course the agglomerates, possibly forming as a result of a juxtaposition of nanoparticles, of the initially forming primary particles can also be larger than 1000 nm.

According to the invention, the particles P are prepared by the reaction of compounds V which can form inorganic nanoparticles X with organic molecules M which comprise functional groups Z. The compounds V can all be identical or different. Furthermore, the organic molecules M, and the functional groups Z can also all be identical or different. The particles according to the invention can thus also be mixtures of different particle types. Preferably, the compounds V are all identical. Particularly preferably, the compounds V are all identical and at the same time the organic molecules M are all identical.

The particles P according to the invention and the nanoparticles X can either be crystalline or amorphous and have varying fractions of crystalline and amorphous structures. Determination takes place by TEM measurements or by X-ray powder diffraction measurements.

The stoichiometric or quantitative composition of the particles P according to the invention comprising the inorganic nanoparticles X and the organic molecules M can vary over a wide range, for example depending on the nature of the compounds V, or the nature of the organic molecules M, as is explained below.

Suitable compounds V are in principle all substances which, through chemical reactions, are able to form inorganic nanoparticles X.

For example, compounds V to be mentioned are those substances which, as a result of a succession of hydrolysis and condensation reactions, can form inorganic nanoparticles (sol gel method).

Preferably, the compounds V used are those substances which lead to the formation of inorganic nanoparticles comprising metal or semimetal oxides, metal or semimetal sulfides, selenides, nitrides, sulfates or carbonates. In this connection, particular preference is given to those compounds V which lead to the formation of inorganic nanoparticles comprising metal or semimetal oxides, particularly preferably to metal oxides. For example, such compounds V comprise the elements Si, Zn, Ti, Ce, Zr, Sn, Fe. Preference is given to Zn, Ti, Sn.

In one embodiment, the compounds V are Ti(OH)₄, Ti(OEt)₄, titanium tetrapropoxide (=Ti(OPr)₄), titanium tetraisopropoxide (=Ti(OiPr)₄), Zn(acetate)₂ (=Zn(OAc)₂), Zn(methacrylate)₂, Zn(benzoate)₂, ZnCl₂, ZnBr₂, Zn(NO₃)₂ or SnCl₄. Preference is given to Zn(OAc)₂, Zn(NO₃)₂, ZnCl₂, Ti(OiPr)₄ or SnCl₄.

In another embodiment of the particles according to the invention, compounds V which are further metal salts are used for the formation of the inorganic nanoparticles.

Preference is given here to using the metal salts of 1 to 5 valent metal cations. The metal salts of 2 to 4 valent metal cations are particularly preferably used. Suitable metal cations are, for example, alkali metal ions, alkaline earth metal ions, earth metal ions, or transition metal ions. Preferred metal cations are Zn(II), Ti(IV), Ce(I), Ce(III), Zr(II), Sn(II), Sn(IV), Fe(II), Fe(III). Particular preference is given to Zn(II), Ti(IV).

When the compounds V are metal salts, preferred anions are acetate, formate or benzoate. Particular preference is given to acetate.

As already mentioned above, preference is likewise given to those compounds V which lead to the formation of inorganic nanoparticles which comprise metal oxides or mixtures thereof. Particular preference in this connection is given to metal oxides of the form AₓO_{y}, where
x is a number from the range from 1 to 3 and
y is a number from the range from 1 to 5 and
A is a metal.

Very particularly preferred metal oxides are ZnO, TiO₂, ZrO₂, CeO₂, Ce₂O₃, SnO₂, SnO, Al₂O₃, SiO₂, or Fe₂O₃. In particular ZnO, TiO₂, ZrO₂, CeO₂, Ce₂O₃, SnO₂.

Preferably, the particles P according to the invention obey the symbolic formula X-M, and the organic molecules M interact with the inorganic nanoparticles X, on the basis of the compounds V. Preferably, this interaction takes place on the surface of the inorganic nanoparticles X and the particles P according to the invention correspond in this case to surface-modified inorganic nanoparticles. The symbolic formula X-M naturally denotes a composition of the particles P according to the invention that is variable within a wide range. This composition comprises the interaction of an organic molecule M with an organic nanoparticle X. Preferably, the symbolic formula X-M denotes the interaction of two or more organic molecules M with an inorganic nanoparticle X.

The structure of the particles P according to the invention can generally vary over a wide range, for example depending on the nature of the compound V. For example, the organic molecules M can be distributed within the particle P, or can be located on the surface of the particle. The distribution of the organic molecules M within the particle P can be homogeneous or heterogeneous. Preferably, the M are located on or essentially on the surface of the particles P. The coverage of the surface of the particles P with the organic molecules M can be complete or partial, for example in the form of individual islands. Very preferably, the organic molecules M, as already mentioned above, are essentially present on the surface of the particles P. The structure of the particles P according to the invention can correspond, in the regions in which no organic molecules M are present, to the structure of the inorganic nanoparticles X that would be present if no organic molecules were present during the formation of the particles P. The distribution of the organic molecules M in the particles P is determined, for example, by determining the crystallinity of the particles P with the help of TEM measurements. For example, distribution of the organic molecules M in the particles P generally disturbs the crystallinity of the particles P to a greater extent than does distribution of the organic molecules M essentially on the surface of the particles P.

In many applications, the inorganic nanoparticles X can also be replaced by particles P according to the invention.

In general, the particles P comprise from 0.1 to 99.9% by weight of the organic compounds M, based on the total weight of the particles P, preferably from 1 to 80% by weight and particularly preferably from 5 to 70% by weight.

Preferably, the inorganic particles X and the particles P according to the invention have a particle size of from 1 nm to 1000 nm. Preferably, the particle size of X and P is from 1 nm to 100 nm. Particularly preferably, the particle size is from 1 nm to 50 nm, very particularly preferably from 1 nm to 30 nm and in particular from 1 nm to 20 nm.

The organic molecules M which comprise functional groups Z are preferably of low molecular weight, i.e. they have a molecular weight of less than 800 g/mol. Very preferably, the molecular weight of the organic molecules is below 600 g/mol, in particular below 500 g/mol.

Preferably, the organic molecules M obey the formula Y′—Z. Here, Y′ denotes a chemical structural unit (linker) via which, if appropriate after a chemical reaction of Y′ to Y, the organic molecules interact with the inorganic nanoparticles X. Preferably, therefore, the particles according to the invention can be described by the following symbolic general formulae (I) and (II):

X—Y′—Z (I)

or

X—Y—Z (II).

For example, the chemical reaction of the linker Y′ to the linker Y takes place by hydrolysis.

The type of interaction between Y′ and X or Y and X can be very different for different Y and Y′. For example, the linker can be covalently bonded to the inorganic nanoparticles X. Furthermore, an electrostatic (ionic) interaction, an interaction via dipole-dipole forces or via hydrogen bridge bonds is also possible. Preferably, the linker interacts with X covalently or electrostatically. The linker can of course also interact with the inorganic nanoparticles at two or more sites, for example form two or more covalent bonds, or, besides a covalent bond, also have further interactions with X, for example via hydrogen bridges.

For example, the linker —Y— corresponds to

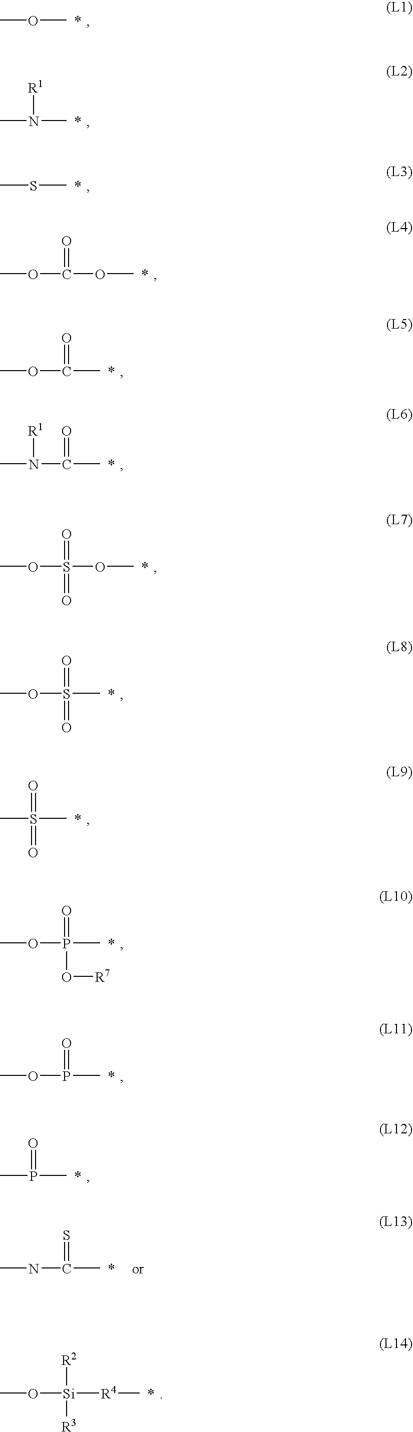

(“*” corresponds to the bonding to the functional group Z)

Here,
R¹ is H, C₁-C₂₀-alkyl, aryl, arylalkyl, heterocycles, C₁-C₂₀-alkylcarbonyl,
R², R³ independently of one another are O, C₁-C₂₀-alkoxy, C₁-C₂₀-alkyl, aryl, arylalkyl, heterocycles,
R⁴ is a chemical single bond, O, C₁-C₂₀-alkylene, C₁-C₂₀-alkylene-R⁵,
R⁵ is O, N, S, N(R⁶)—C═O, N—CO₂, O₂C, O₂CN, OCO₂,

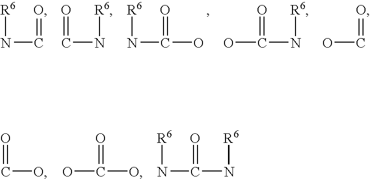

R⁶ is H, C₁-C₂₀-alkyl,
R⁷ is H, metal cation,
   where the substituents R¹ to R⁴ and/or R⁶ may in each case be interrupted at any desired position by one or more heteroatoms, where the number of these heteroatoms is not more than 10, preferably not more than 8, very particularly preferably not more than 5 and in particular not more than 3, and/or can in each case be substituted at any desired position, but not more than five times, preferably not more than four times and particularly preferably not more than three times, by C₁-C₂₀-alkyl, C₁-C₂₀-alkoxy, aryl, aryloxy, heterocycles, heteroatoms or halogen, where these can likewise be substituted a maximum of twice, preferably a maximum of once, with the specified groups. Metal cations are preferably mono-, di- or trivalent metal cations, for example alkali metal, alkaline earth metal, earth metal, transition metal cations. In particular, metal cations are Li⁺, Na⁺, K⁺, Ca²⁺ and/or Mg²⁺. For the valence of the metal cations, it should naturally be taken into consideration that electroneutrality is still ensured overall. For example, a divalent metal cation neutralizes two linkers L10. A formation of ionic interactions, for example salt bridges, between linkers L10 is possible.

Preferred linkers —Y— are L1, L5, L8, L10 or L14.

Preferred silane linkers L14 are

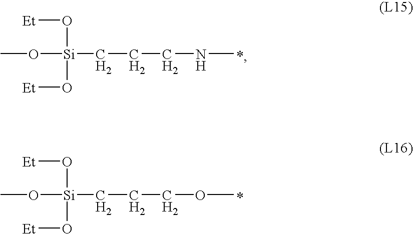

(* symbolizes the bonding site to the functional group Z) or (partially) hydrolyzed derivatives of these silane linkers L15 or L16.

In one embodiment of the particles according to the invention, the organic molecules M interact not only with the compounds V, but also with one another. For example, the organic molecules M can interact with one another via electrostatic interactions or hydrogen bridge bonds with one another. It is likewise possible that the organic molecules M react with one another in a chemical reaction, before or after a possible chemical reaction with the inorganic nanoparticles. For example, this is possible in the form of a crosslinking reaction between the organic molecules M. This crosslinking can take place before, during or after the formation of the particles P. Preferably, such a crosslinking takes place if the organic molecules carry silane groups which are capable of condensation reactions. The crosslinking reaction can, if the organic molecules M are located on the surface of the particles P, lead to the formation of a completely crosslinked coating, or else also produce only partially crosslinked areas on the surface.

The functional group Z of the organic molecule can be very different depending on the use of the particles according to the invention. For example, the functional group Z comprises a chromophore which can absorb electromagnetic radiation. Such a chromophore is, for example, able to absorb IR, visible, or UV light. For example, such a chromophore can then emit the absorbed light again, if appropriate at another wavelength (fluorescence or phosphorescence), or else give off the absorbed light energy in a nonradiative manner. Furthermore, combined processes of emission and nonradiative deactivation are also possible.

Furthermore, besides UV absorbers, the functional group Z comprises, for example, stabilizers for organic polymers, auxiliaries for organic polymers, flame retardants, organic dyes, or IR dyes, fluorescent dyes, optical brighteners, antistatic agents, antiblocking agents, nucleating agents, antimicrobial additives.

Preferably, the functional group Z comprises a chromophore which absorbs UV light with a wavelength of less than 400 nm, in particular from 200 to 400 nm (UV absorber). A chromophore of this type can therefore absorb, for example, UV-A (from 320 to 400 nm), UV-B (from 290 to 319 nm) and/or UV-C (from 200 to 289 nm) light. Preferably, the chromophore absorbs UV-A and/or UV-B light. Very particularly preferably, the chromophore absorbs UV-A and/or UV-B light and deactivates the absorbed light energy in a nonradiative manner.

For example, the functional group Z corresponds to

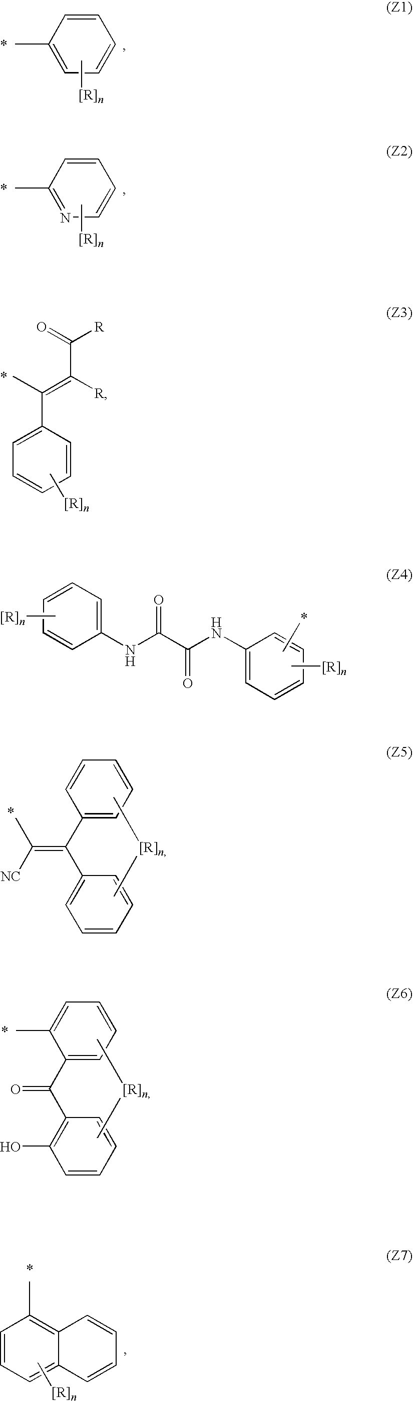

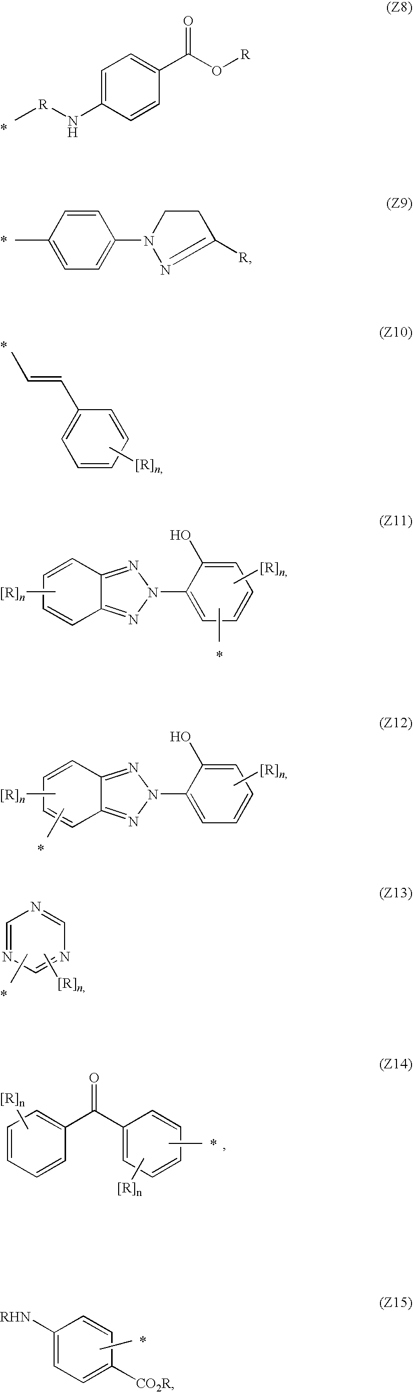

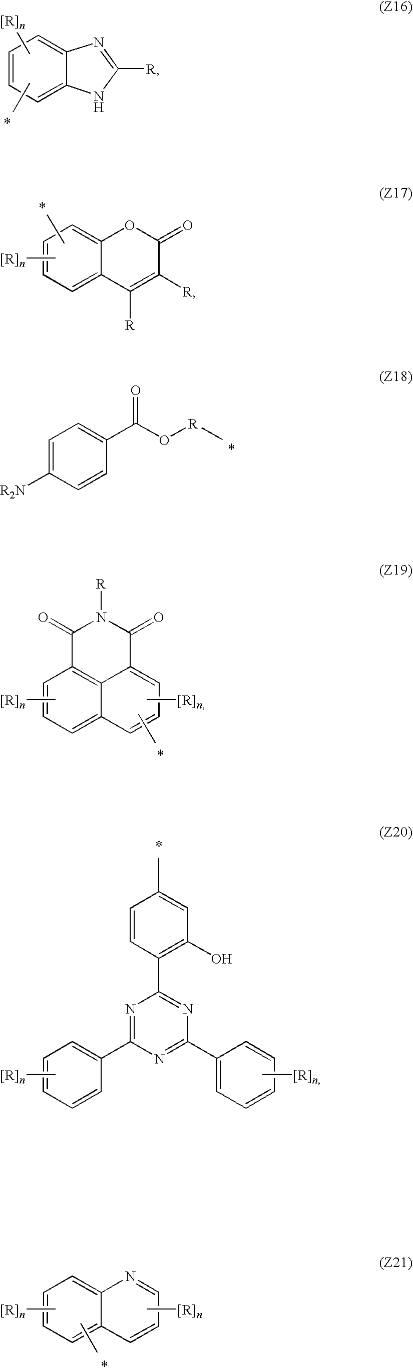

(*symbolizes the bonding site to the linker Y or Y′)
where
R is halogen, hydroxy, phenyl, C₁-C₂₀-alkyl, hydroxyphenyl, C₁-C₂₀-alkoxy, aryl, aryloxy, amino, mono- or dialkylamino, nitrile, carboxylate, ester, thiol, sulfoxides, sulfonic acid, acyl, formyl, carbonyloxyalkyl, carbonylaminoalkyl
n is an integer from the range from 0 to 4,
   and the n substituents R, independently of one another, may be identical or different, and where the substituent R can be interrupted at any desired position by one or more heteroatoms, where the number of these heteroatoms is not more than 10, preferably not more than 8, very particularly preferably not more than 5 and in particular not more than 3, and/or can in each case be substituted at any desired position, but not more than five times, preferably not more than four times and particularly preferably not more than three times, by C₁-C₂₀-alkyl, C₁-C₂₀-alkoxy, aryl, aryloxy, heterocycles, heteroatoms or halogen, where these can likewise be substituted a maximum of twice, preferably a maximum of once, with the specified groups.

Preferably, the particles P according to the invention absorb light with a wavelength from 200 to 600 nm. Furthermore, the absorption spectrum of the particles according to the invention preferably has at least one absorption maximum in the wavelength range from 200 to 600 nm. Preferably, particles P according to the invention absorb UV-A and/or UV-B light. Very particularly preferably, the particles P according to the invention absorb UV-A and/or UV-B light and deactivate the absorbed light energy in a nonradiative manner.

The UV absorbers used are preferably organic molecules M which have a linker Y or Y′.

UV absorbers are often commercial products. They are sold, for example, under the tradename Uvinul® by BASF Aktiengesellschaft, Ludwigshafen. The Uvinul® photoprotective agents comprise compounds of the following classes: benzophenones, benzotriazoles, cyanoacrylates, cinnamic acid esters, para-aminobenzoates, naphthalimides. Moreover, further known chromophores are used, e.g. hydroxyphenyltriazines or oxalanilides. Such compounds are used, for example, on their own or in mixtures with other photoprotective agents in cosmetic applications, for example sunscreen compositions or for the stabilization of organic polymers. A UV absorber used with particular preference is 4-n-octyloxy-2-hydroxybenzophenone. Further examples of UV absorbers are:

substituted acrylates, such as, for example, ethyl or isooctyl α-cyano-β,β-diphenylacrylate (primarily 2-ethylhexyl α-cyano-β,β-diphenylacrylate), methyl α-methoxycarbonyl-β-phenylacrylate, methyl α-methoxycarbonyl-β-(p-methoxyphenyl)acrylate, methyl or butyl α-cyano-β-methyl-β-(p-methoxyphenyl)acrylate, N-(β-methoxycarbonyl-β-cyanovinyl)-2-methylindoline, octyl p-methoxycinnamate, isopentyl 4-methoxycinnamate, urocanic acid or salts or esters thereof;
derivatives p-aminobenzoic acid, in particular esters thereof, e.g. ethyl 4-aminobenzoate or ethoxylated ethyl 4-aminobenzoate, salicylates, substituted cinnamic acid esters (cinnamates) such as octyl p-methoxycinnamate or 4-isopentyl 4-methoxycinnamate, 2-phenylbenzimidazole-5-sulfonic acid or its salts.
2-hydroxybenzophenone derivatives, such as, for example, 4-hydroxy-, 4-methoxy-, 4-octyloxy-, 4-decyloxy-, 4-dodecyloxy-, 4-benzyloxy-, 4,2′,4′-trihydroxy-, 2′-hydroxy-4,4′-dimethoxy-2-hydroxybenzophenone, and 4-methoxy-2-hydroxybenzophenonesulfonic acid sodium salt;
esters of 4,4-diphenylbutadiene-1,1-dicarboxylic acid, such as, for example, the bis(2-ethylhexyl) ester;
2-phenylbenzimidazole-4-sulfonic acid and 2-phenylbenzimidazole-5-sulfonic acid or salts thereof;
derivatives of benzoxazoles;
derivatives of benzotriazoles or 2-(2′-hydroxyphenyl)benzotriazoles, such as, for example, 2-(2H-benzotriazol-2-yl)-4-methyl-6-(2-methyl-3-((1,1,3,3-tetramethyl-1-(trimethylsilyloxy)disiloxanyl)propyl)phenol, 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-[2′-hydroxy-5′-(1,1,3,3-tetramethylbutyl)phenyl]benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-[3′,5′-bis(α,α-dimethylbenzyl)-2′-hydroxyphenyl]benzotriazole, 2-[3′-tert-butyl-2′-hydroxy-5′-(2-octyloxycarbonylethyl)phenyl]-5-chlorobenzotriazole, 2-[3′-tert-butyl-5′-(2-(2-ethylhexyloxy)-carbonylethyl)-2′-hydroxyphenyl]-5-chlorobenzotriazole, 2[3′-tert-butyl-2′-hydroxy-5′-(2-methoxycarbonylethyl)phenyl]-5-chlorobenzotriazole, 2-[3′-tert-butyl-2′-hydroxy-5′-(2-methoxycarbonylethyl)phenyl]benzotriazole, 2-[3′-tert-butyl-2′-hydroxy-5′-(2-octyloxycarbonylethyl)phenyl]benzotriazole, 2-[3′-tert-butyl-5′-(2-(2-ethylhexyloxy)carbonylethyl)-2′-hydroxyphenyl]benzotriazole, 2-(3′-dodecyl-2′-hydroxy-5′-methylphenyl)benzotriazole, 2-[3′-tert-butyl-2′-hydroxy-5′-(2-isooctyloxycarbonylethyl)phenyl]benzotriazole, 2,2′-methylenebis[4-(1,1,3,3-tetramethylbutyl)-6-benzotriazol-2-ylphenol], the completely esterified product of 2-[3′-tert-butyl-5′-(2-methoxycarbonylethyl)-2′-hydroxyphenyl]-2H-benzotriazole with polyethylene glycol 300, [R—CH2CH2-COO(CH2)3-]2 where R is 3′-tert-butyl-4-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole;
benzylidenecamphor or its derivatives, as are specified, for example, in DE-A 38 36 630, e.g. 3-benzylidenecamphor, 3-(4′-methylbenzylidene)-dl-camphor;
α-(2-oxoborn-3-ylidene)toluene-4-sulfonic acid or its salts, N,N,N-trimethyl-4-(2-oxoborn-3-ylidenemethyl)anilinium monosulfate;
dibenzoylmethanes, such as, for example, 4-tert-butyl-4′-methoxydibenzoylmethane;
2,4,6-triaryltriazine compounds such as 2,4,6-tris{N-[4-(2-ethylhex-1-yl)oxycarbonylphenyl]amino}-1,3,5-triazine, bis(2′-ethylhexyl) 4,4′-((6-(((tert-butyl)aminocarbonyl)phenylamino)-1,3,5-triazine-2,4-diyl)imino)bisbenzoate;
2-(2-hydroxyphenyl)-1,3,5-triazines, such as, for example, 2,4,6-tris(2-hydroxy-4-octyloxyphenyl)1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis-(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis-(2,4-dimethylphenyl)-1,3,5-triazine, 2-(2-hydroxy-4-tridecyloxyphenyl)-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4(2-hydroxy-3-dodecyloxypropoxy)phenyl]-4,6-bis-(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Further suitable UV absorbers can be found in the publication Cosmetic Legislation, Vol. 1, Cosmetic Products, European Commission 1999, pp. 64-66, to which reference is hereby made.

Furthermore, suitable UV absorbers are described in lines 14 to 30 ([0030]) on page 6 of EP 1 191 041 A2. Reference is made to the entire contents of this and this literature reference is made part of the disclosure content of the present invention.

According to the invention, therefore, particles P which comprise UV absorbers as organic molecules M can be used for the stabilization of polymers against the effect of UV light.

The present invention further provides a general method for the stabilization of polymers against the effect of light, free radicals or heat, where nanoparticles to whose surface organic, light-absorbing compounds, for example UV absorbers, have been attached are added to the polymers. This general method according to the invention can of course be carried out with the help of the corresponding particles P according to the invention which essentially have light-absorbing compounds on their surface, but is not limited to these. In general, all nanoparticles can be used which have organic light-absorbing compounds on their surface, for example surface-modified nanoparticles. The preparation of such surface-modified nanoparticles is known, for example, from the specifications WO 2006/099952 A2, EP 1 205 177 or WO 2007/017586. Reference is explicitly made to the examples of surface-modified particles in the specifications WO 2006/099952 A2 (p. 3-p. 16), EP 1 205 177 ([0013], [0071]-[0076]) or WO 2007/017586)[0012]-[0055]) and these literature references are made part of the disclosure content of the present invention.

The invention further provides the use of nanoparticles to whose surface organic, light-absorbing compounds are attached for the stabilization of polymers against the effect of light, free radicals or heat.

The incorporation of the nanoparticles to whose surface organic, light-absorbing compounds are attached into polymers can take place according to the same methods as the incorporation of the particles P according to the invention into polymers.

The use of inorganic nanoparticles X, for example of nanoparticles based on ZnO and TiO₂ in polymers often leads, due to the photocatalytic effect of the nanoparticles, to the damage or destruction of the polymer matrix and thus to a deterioration in the properties of the polymers. The particles P according to the invention have the advantage that the photocatalytic activity is reduced or completely suppressed if UV absorbers are used as organic molecules M.

The particles P prepared with the help of UV absorbers as organic molecules M by the method according to the invention have the further advantage that, as a rule, the UV absorbers are present in stabilized form. By incorporating the UV absorbers into the particles P according to the invention, the life span of the UV absorbers is generally extended and premature photochemical destruction of the UV absorbers is prevented. This effect contributes to an effective reduction in the required amount of UV absorbers.

Furthermore, suitable organic molecules M are stabilizers for organic polymers. The stabilizers are compounds which stabilize organic polymers against degradation upon the action of oxygen, light (apart from UV) or heat. They are also referred to as antioxidants or as light stabilizers, cf. Ullmanns, Encyclopedia of Industrial Chemistry, Vol. 3, 629-650 (ISBN-3-527-30385-5) and EP-A 1 110 999, page 2, line 29 to page 38, line 29. Using such stabilizers it is possible to stabilize virtually all organic polymers, cf. EP-A 1 110 999, page 38, line 30 to page 41, line 35. This literature reference is made part of the disclosure content of the present invention by reference. The stabilizers described in the EP application belong to the compound class of the pyrazolones, of the organic phosphites or phosphonites, of the sterically hindered phenols and of the sterically hindered amines (stabilizers of the so-called HALS type or HALS stabilizers, cf. Römpp, 10th edition, Volume 5, pages 4206-4207. According to the invention, therefore, particles P which comprise stabilizers as organic molecules M can be used for the stabilization of polymers.

In a preferred embodiment, mixtures of particles P which comprise UV absorbers and specific auxiliaries for organic polymers as organic molecules M are used. For example, these auxiliaries are flame retardants, organic dyes, IR dyes, fluorescent dyes, optical brighteners, nucleating agents, antimicrobial additives. Depending on the field of application, the ratio of auxiliaries to UV absorbers can vary greatly. For example, the ratio of UV absorbers to auxiliaries is from 10:1 to 1:10, preferably from 5:1 to 1:5, in particular from 2:1 to 1:2.

Further suitable organic molecules M are auxiliaries for organic polymers. Auxiliaries are to be understood as meaning, for example, substances which at least largely prevent the blooming of films or molded parts made of plastics, so-called antifogging agents. Furthermore suitable as polymer additives are antiblooming agents for organic polymers from which in particular plates or films are produced. Such polymer additives are described, for example, by F. Wylin, in Plastics Additives Handbook, 5th Edition, Hanser, ISBN1-56990-295-X, pages 609-626. According to the invention, therefore, particles P which comprise auxiliaries as organic molecules M can be used as antifogging or antiblooming agents.

Further suitable organic molecules M are lubricants, such as oxidized polyethylene waxes, and antistatics for organic polymers. Examples of antistatics cf. the aforementioned literature reference F. Wylin, Plastics Additives Handbook, pages 627-645.

Further suitable organic molecules M are flame retardants, which are described, for example, in Römpp, 10th edition, pages 1352 and 1353 and also in Ullmanns, Encyclopedia of Industrial Chemistry, Vol. 14, 53-71. According to the invention, therefore, particles P which comprise flame retardants as organic molecules M can be used as flame retardants for polymers.

Standard commercial stabilizers and auxiliaries are sold, for example, under the tradenames Tinuvin®, Chimassorb®, and Irganox® by Ciba, Cyasorb® and Cyanox® by Cytec, Lowilite®, Lowinox®, Anox®, Alkanox®, Ultranox® and Weston® by Chemtura and Hostavin® and Hostanox® by Clariant. Stabilizers and auxiliaries are described, for example, in Plastics Additives Handbook, 5th edition, Hanser Verlag, ISBN 1-56990-295-X.

Other organic molecules M are organic dyes which absorb light in the visible region, or optical brighteners. Such dyes and optical brighteners are described in detail in WO 99/40123, cited as prior art, page 10, line 14 to page 25, line 25, to which reference is hereby expressly made. Whereas organic dyes have an absorption maximum in the wavelength range from 400 to 850 nm, optical brighteners have one or more absorption maxima in the range from 250 to 400 nm. As is known, upon irradiation with UV light, optical brighteners emit fluorescent radiation in the visible region. Examples of optical brighteners are compounds from the classes of bisstyrylbenzenes, stilbenes, benzoxazoles, coumarins, pyrenes and naphthalenes. Standard commercial optical brighteners are sold under the names Tinopal® (Ciba), Ultraphor® (BASF Aktiengesellschaft) and Blankophor® (Bayer). Optical brighteners are also described in Römpp, 10th edition, Volume 4, 3028-3029 (1998) and in Ullmanns, Encyclopedia of Industrial Chemistry, Vol. 24, 363-386 (2003). According to the invention, therefore, particles P which comprise organic dyes or brighteners as organic molecules M can be used for the coloring or brightening of polymers.

Further suitable organic molecules M are IR dyes which are sold, for example, by BASF Aktiengesellschaft as Lumogen® IR. Lumogen® dyes comprise compounds of the classes of perylenes, naphthalimides, or quaterylenes. According to the invention, therefore, particles P which comprise IR dyes as organic molecules M can be used as IR absorbers for polymers or for the invisible marking of polymers.

In particular, preference is given to particles P which are obtainable by reacting compounds V which lead to the formation of ZnO in the presence of benzophenones.

In particular, preference is also given to particles P which are obtainable by reacting compounds V which lead to the formation of ZnO in the presence of salicylic acid.

Furthermore, preference is given to particles P which are obtainable by reacting compounds V which lead to the formation of ZnO in the presence of organic molecules M, of the formula Y′—Z or Y—Z, where Y is a silane linker (L14) and Z has the function of a UV absorber.

Furthermore, preference is given to particles P which are obtainable by reacting compounds V which lead to the formation of TiO₂ in the presence of organic molecules M of the formula Y′—Z or Y—Z, where Y is a carboxyl linker (L5) and Z has the function of a UV absorber.

Furthermore, preference is given to particles P which are obtainable by reacting compounds V which lead to the formation of TiO₂ in the presence of organic molecules M, of the formula Y′—Z or Y—Z, where Y is a sulfonic acid linker (L8) and Z has the function of a UV absorber.

Furthermore, preference is given to particles P which are obtainable by reacting compounds V which lead to the formation of TiO₂ in the presence of organic molecules M, of the formula Y′—Z or Y—Z, where Y is a silane linker (L14) and Z has the function of a UV absorber.

In particular, preference is also given to particles P which are obtainable by reacting compounds V which lead to the formation of ZnO in the presence of organic molecules M, of the formula Y′—Z or Y—Z, where Y is the linker L1 and Z is a group Z2.

Preferred particles P according to the invention are those particles in which all of the features adopt their preferred meaning.

The particles according to the invention can of course be modified subsequently on their surface using methods known from the prior art (EP 1 205 177 A2, WO 93/21127).

The particles P according to the invention are prepared by reacting compounds V which can form inorganic nanoparticles X with organic molecules M which comprise functional groups Z, where the molecules M and the compounds V are present together during the formation process of the particles P.

As already explained above, it is possible with the aid of the compounds V to form inorganic nanoparticles. The inorganic nanoparticles X can also be formed here in the absence of the organic molecules M. According to the invention, however, the compounds V and the organic molecules M are present together in the course of formation of the particles P. The organic molecules M preferably influence the formation of inorganic nanoparticles from the compounds V to the effect that not the inorganic nanoparticles X but the inventive particles P form in the course of reaction of the compounds V. Most preferably, the remaining reaction conditions that would lead to the inorganic nanoparticles in a reaction of the compounds V are unchanged apart from the presence of the organic molecules.

In one embodiment, the preparation of the particles P according to the invention comprises the following steps:
(a) preparation of the compound V optionally dissolved in a solvent and the organic molecules M optionally dissolved in a solvent,
(b) mixing of the compounds V with the organic molecules M, optionally in a solvent,
(c) reaction of the mixture from (b), optionally with addition of further substances or of further organic molecules M, optionally under the reaction conditions which would lead to the formation of nanoparticles X from compounds V, to give inventive particles P,
(d) optionally isolation of the particles P,
(e) optionally purification and work-up of the particles P,
(f) optional further modification of the particles P,
(g) optionally redispersion of the particles P.

In a preferred embodiment of the method according to the invention for the preparation of the particles P, in step (a), the organic molecules M or the compounds V are dissolved in a solvent. Particularly preferably, both the compounds V and the organic molecules are dissolved in a solvent and are mixed in dissolved form, in particular the compounds V and the organic molecules M are dissolved in the same solvent.

Furthermore, in the method according to the invention, in step (c), the addition of further substances, for example initiators or catalysts for the formation of the inorganic nanoparticles, or further organic molecules M, is preferred. Initiators or catalysts for the formation of the inorganic nanoparticles are understood to mean substances which induce or accelerate the formation of the particles P. For example, the further substances used are bases, in particular EtONa, EtOK, EtOLi, PrONa, MeONa, NaOH, LiOH, KOH, trialkylamines, tetraalkylammonium hydroxides, or acids, in particular HCl, H₂SO₄, HNO₃, acetic acid, or salts, in particular tetraalkylammonium halides.

Preferably, further organic molecules M are added in step (c). The addition of these further organic molecules M can be used in order to control the particle size of the particles P or in order to introduce additional functional groups Z into the particles P. In general, the particle size depends on the concentration of the organic molecules M; the higher the concentration of the M, the lower the particle size of the particles P generally is. By means of the addition of further organic molecules M, it is possible to introduce additional functional Z groups into the particles P. The Z here may all be the same or different. Preferably, with the help of the method according to the invention, particles P can be prepared with various Z. The particles P according to the invention prepared with various Z generally have combined properties based on the various Z. For example, in this way it is possible to prepare particles P which comprise various UV absorbers and thus cover the entire required absorption spectrum. Further combinations of functional groups are, for example, flame retardants with dyes or UV absorbers with flame retardants. Further combinations can be selected depending on the desired area of application. Such combinations often exhibit synergies.

Very preferably, in the preparation method according to the invention, a solvent is used in step (a) and further substances or further molecules M are added in step (c).

In one preferred embodiment, the preparation of the particles P according to the invention comprises the following steps: (a) preparation of Zn(OAc)₂ and UV absorber. (b) Mixing of Zn(OAc)₂ and UV absorber in polar solvent, preferably ethanol or water. (c) Reaction of the mixture from (b) in the presence of base, preferably NaOH or LiOH, to give inventive particles P. (d) Optionally isolation of the particles P. (e) Optionally cleaning and work-up of the particles P. (f) Optional further modification of the particles P. (g) Optionally redispersion of the particles P.

In a further preferred embodiment, the preparation of the particles P according to the invention comprises the following steps: (a) preparation of Ti(OiPr)₄ and UV absorber. (b) Mixing of Ti(OiPr)₄ and UV absorber in polar solvent, preferably ethanol or water. (c) Reaction of the mixture from (b) in the presence of base, preferably NaOH or LiOH, to give inventive particles P. (d) Optionally isolation of the particles P. (e) Optionally cleaning and work-up of the particles P. (f) Optional further modification of the particles P. (g) Optionally redispersion of the particles P.

In a further preferred embodiment, the preparation of the inventive particles P comprises the following steps: (a) provision of Ti₁₆O₁₆(OEt)₃₂ according to literature method (C. Sanchez et al., J. Am. Chem. Soc. 2005, 127, 4869-4878, R. Schmid, A. Mosset and J. Galy, J. Chem. Soc., Dalton Trans., 1991, 1999) and UV absorber. (b) Mixing of Ti₁₆O₁₆(OEt)₃₂ and UV absorber in polar solvent, preferably ethanol or water. (c) Reaction of the mixture from (b) in the presence of base, preferably NaOH or LiOH, to give inventive particles P. (d) Optionally isolation of the particles P. (e) Optionally cleaning and work-up of the particles P. (f) Optional further modification of the particles P. (g) Optionally redispersion of the particles P.

Preferably, the optional further modification of the particles P comprises (f) a chemical modification of the particles P, in particular on the organic molecules M, very preferably a chemical reaction on the functional groups Z. For example, in this embodiment of the method according to the invention, a (subsequent) conversion of the functional group Z from an inactive form to an active form is possible.

Pressure and temperature are generally of secondary importance for the preparation of the particles P according to the invention. The choice of temperature can have an influence on the particle size and naturally depends on the compounds V used. Usually, the reaction temperature is in the range from −5° C. to 300° C., often in the range from 10 to 150° C. Preferably, the reaction temperature is in the range from 20 to 70° C. The reaction is usually carried out at atmospheric pressure or ambient pressure.

However, it can also be carried out in the pressure range of up to 50 bar.

The solids content of the liquid formulations according to the invention is determined in a first approximation through the particles P according to the invention and varies within a wide range depending on the application. As a rule, the solids content is in the range from 1 to 90% by weight and in particular in the range from 5 to 70% by weight, based on the total weight of the liquid formulation.

The liquid formulations according to the invention can be directly used as such or following dilution. Furthermore, the liquid formulations according to the invention can also comprise customary additives, e.g. additives that change the viscosity (thickeners), antifoams, bactericides, agents to protect against frost and/or surface-active substances. The surface-active substances include protective colloids, but also low molecular weight emulsifiers (surfactants), where, in contrast to the protective colloids, the latter generally have a molecular weight below 2000 g/mol, in particular below 1000 g/mol (mass average). The protective colloids or emulsifiers may either be anionic, nonionic, cationic, or zwitterionic in nature.

In addition, the liquid formulations according to the invention can be formulated with conventional binders, for example aqueous polymer dispersions, water-soluble resins or with waxes.

The particles P according to the invention are present in the liquid formulations and can be obtained in powder form from these liquid formulations (step (d) and (e) of the method according to the invention by removing the volatile constituents of the liquid phase. Within the powder, the particles according to the invention can either be present singly, in agglomerated form, or else partially in filmed form. The powders according to the invention are accessible here, for example, by evaporating the liquid phase, freeze-drying or by spray-drying.

Liquid formulations according to the invention are often accessible by redispersing (step (f) of the method according to the invention) of the powders according to the invention, for example in ethanol or toluene.

The liquid formulations according to the invention and the powders according to the invention obtainable therefrom by separating off the liquid phase have the advantage that they comprise the organic molecules M in migration-stable form controlled over a long period, i.e. the organic molecules M are associated with the particles P over a prolonged period and are not released to the surroundings outside of the particles P. Furthermore, the inorganic constituents of the nanoparticles are often also likewise held tight in the particles P through the modification with the organic molecules M and are not released to the surroundings. The organic molecules M and/or the inorganic nanoparticles are thus present in a form that is particularly advantageous for their application. This fact applies in particular for those liquid formulations or particle powders which comprise a UV absorber. The migration stability can be measured, for example, through spray-drying the liquid formulation and subsequent extraction of the powder with tetrahydrofuran (THF), by determining the fraction of the organic molecules M recovered by extraction. Furthermore, according to the invention, in the case of metal-containing inorganic nanoparticles, the metals are often prevented from escaping from the particles P. Thus, for example, the toxic effect of the metal (cations) can be controlled.

The particles according to the invention in the form of their liquid formulations or powders are preferably used for the finishing, for example for the stabilization, of organic polymers. For this purpose, the particles can be incorporated into the organic polymers either as liquid formulation, or else as powder by the customary methods. Mention is to be made here, for example, of the mixing of the particles with the organic polymers before or during an extrusion step. In general, it is also possible to incorporate other nanoparticles, for example surface-modified nanoparticles, into organic polymers together with the inventive particles or else alone, for example as additives or fillers.

After incorporating the particles P according to the invention into the organic polymers, the particles P are present in the polymer matrix and the organic molecules are present according to the invention in the organic polymers in migration-stable form. The migration stability can be applied analogously to the method given above (extraction with THF) for particle powders also to polymer powders which comprise particles P. Furthermore, the migration stability can be tested by optical determination. For this, films are prepared from the organic polymers comprising the particles P, for example by extrusion, said films being stored at elevated temperature (e.g. 60° C.). After a certain time, for example one to two weeks, it can be established through an optical test whether the particles P have migrated on the surface of the films (formation of visible deposits).

Inanimate organic polymers are to be understood here as meaning any plastics, preferably thermoplastic material, in particular films, fibers or moldings of any configuration. Within the context of this application, these are also simply referred to as organic polymers. Further examples of the finishing or stabilization of organic polymers with polymer additives can be found in the Plastics Additives Handbook, 5th edition, Hanser Verlag, ISBN 1-56990-295-X. The organic polymers are preferably polyolefins, in particular polyethylene or polypropylene, polyamides, polyacrylonitriles, polyacrylates, polymethacrylates, polycarbonates, polystyrenes, copolymers of styrene or methylstyrene with dienes and/or acrylic derivatives, acrylonitrile-butadiene-styrenes (ABS), polyvinyl chlorides, polyvinyl acetals, polyurethanes or polyesters. Organic polymers can also be copolymers, mixtures or blends of the abovementioned polymers. Particularly preferred polymers are polyolefins, in particular polyethylene or polypropylene.

In order to stabilize a thermoplastic polymer against the effect of UV, the procedure may, for example, involve initially melting the polymer in an extruder, incorporating, at a temperature of, for example, 180 to 200° C., a particle powder comprising UV absorber and prepared according to the invention, and preparing from this granules from which, by known methods, films, fibers or moldings are then produced which are stabilized against the effect of UV radiation.

Within the context of the use according to the invention, mixtures of different particles according to the invention can also naturally be used. The particles of these mixtures can have identical or different compositions and size distributions. For example, particles comprising UV absorbers can also be used together with other particles according to the invention which comprise, for example, stabilizers for organic polymers such as antioxidants for the stabilization of organic polymers and coats of paint.

Of technical interest are, for example, those liquid formulations according to the invention or the powders obtained therefrom by, for example, spray-drying, which comprise particles according to the invention which comprise at least one antioxidant, for example phenolic compounds, such as, for example, pentaerythritol tetrakis[3-(3′,5′-di-tert-butyl-4′-hydroxyphenyl)propionate] (obtainable for example as Irganox® 1010 from Ciba SC). Also of interest are particle powders which comprise at least one antistatic for organic polymers or an antimisting agent for organic polymers or a colorant for organic polymers.

Preference is given to liquid formulations according to the invention which comprise UV absorbers and stabilizers.

For the use for the finishing, for example for the stabilization, of organic polymers, the particles P according to the invention can also be used together with other additive systems in order to improve the overall effectiveness. For example with conventional emulsion concentrates, suspension concentrates, suspoemulsion concentrates of polymer additives. By mixing the particles according to the invention with conventional preparations of the aforementioned polymer additives, firstly a broadening of the activity spectrum is achieved if the conventional preparation comprises polymer additives other than the particles according to the invention. Secondly, the advantages of the particles according to the invention do not become lost through the formulation with conventional polymer additive preparations, in particular the improved migration stability. Consequently, the application properties of a conventional polymer additive preparation can be improved through formulation with particles P according to the invention which comprise the same polymer additives. In particular, on account of the improved migration stability, it is possible, while retaining the same effectiveness, to reduce the amount of additives used.

In one preferred embodiment, the particles P according to the invention are used together with further stabilizers for stabilizing polymers. In particular, the further stabilizers used here are UV absorbers, antioxidants, sterically hindered amines, nickel compounds, metal deactivators, phosphites, phosphonites, hydroxylamines, nitrones, amine oxides, benzofuranones, indolinones, thiosynergists, peroxide-destroying compounds or basic costabilizers.

The liquid formulations according to the invention are associated with a series of further advantages. Firstly, they are stable formulations of the particles P, for example of polymer additives. In particular, the phase separation problems observed with other formulations and in the case of micro- or nanodispersions of the polymer additives, and settling of the polymer additive are not observed, even when using drastic conditions as sometimes arise during the finishing of organic polymers with polymer additives. The washing-out of the polymer additive from the treated organic polymer upon the action of water is significantly reduced compared to other formulations. Furthermore, interactions of the polymer additives with other formulation constituents or copolymer additives, as often arise during conventional formulation, are not observed. Moreover, the degradation of the polymer additives through substrate or environmental influences, such as pH of the medium or UV radiation, is slowed or completely suppressed altogether. Reduced effectiveness of the polymer additives as a result of being integrated into a polymer matrix is surprisingly generally not observed.

A further advantage of the preparation method according to the invention is that the particle size of the particles P according to the invention can be adjusted in a controlled manner. In particular, it is possible, as already mentioned above, to set the particle size of the particles P in a controlled manner via the concentration of the organic molecules M in the mixture with the compounds V. For example, the use of salicylic acid in the presence of compounds V which lead to the formation of ZnO nanoparticles, with addition of base, for example NaOH, depending on the concentration of salicylic acid, can set particles sizes of 2 to 10 nm. The greater the concentration of the organic molecules, the smaller the particle size of the particles P according to the invention. For example, at a molar ratio of Zn(OAc)₂:salicylic acid of 1:0.5, particles sizes of approx. 2 nm can be obtained. At a molar ratio Zn(OAc)₂:salicylic acid of, for example, 1:0.1, particle sizes of about 5 nm are obtained.

By repeated addition of different amounts of organic molecules M (step (c) of the preparation method according to the invention), the particle size and composition of the particles P can be varied further. By means of such a variation of the particle size, it is also possible to adjust the properties of the particles P. For example, nanoparticles based on ZnO or TiO₂, depending on the particle size, have different UV absorptions. According to the invention it is therefore possible, for example, to vary the UV absorption properties of the particles P depending on use. Further properties which the person skilled in the art can establish through routine experiments are, for example, the solubility properties of the particles P or the transparency of the materials comprising the particles P.

The preparation method of the particles P according to the invention permits a very efficient access to the particles. The particles according to the invention are present, for example, as constituents of liquid formulations or of powders and can be readily incorporated into organic polymers.

The particles according to the invention are particularly suitable for the finishing, for example against static charging or misting and/or stabilization, for example against oxidation, effect of UV rays, heat and/or light, of organic polymers.

The examples below are intended to illustrate the invention but without limiting it.

### EXAMPLES

All equivalents (eq) are mol equivalents.

Room temperature (RT): 21° C.

### Comparative Example 1

### ZnO Nanoparticles

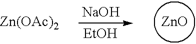

A 1 molar ethanolic sodium hydroxide solution (1 eq) was added to a 0.03 molar ethanolic zinc acetate solution (1 eq), and the mixture was stirred at room temperature.

The growth of the zinc oxide nanoparticles was monitored by UV spectroscopy. The particles grew continuously and precipitated out in the solution after a certain time.

Analysis: TEM showed crystalline ZnO particles of particle size approx. 4 to 5 nm.

Use of lithium hydroxide resulted in smaller particles (from 2 to 3 nm) and use of potassium hydroxide in larger particles (from 5 to 10 nm).

### Example 1

### ZnO Modified with a Chromophore

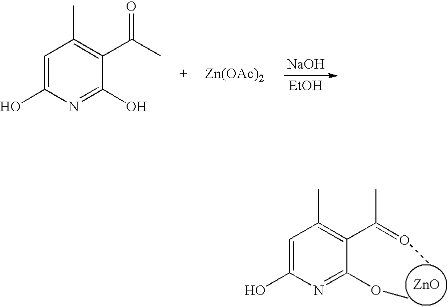

Ethanolic solutions of sodium hydroxide (1 eq), zinc acetate (1 eq) and 2,6-dihydroxy-4-methyl-3-acetylpyridine (UV-absorbing chromophore) (0.5 eq) were mixed and the mixture was stirred at room temperature. After reaction at room temperature for 1 hour, the solution was concentrated to dryness in order to obtain surface-modified ZnO nanoparticles. This solution remained stable for several months, without the particles growing further.

A powder obtained from a portion of the solution was redispersible in ethanol.

Preparation (Including Powder):

300 ml (9 mmol) of zinc acetate*2H₂O (0.03 molar solution in ethanol, absolute) was initially charged, and, at room temperature 9 ml (9 mmol) of sodium hydroxide (1 molar solution in ethanol, absolute) and 150 ml (4.5 mmol) 2,6-dihydroxy-4-methyl-3-acetylpyridine (0.03 molar solution in methanol). The solution turns light brown immediately. After reaction at room temperature for 1 h, the product solution was concentrated to dryness on a rotary evaporator at room temperature and 0-10 mbar within 3 h.

This gave 2.8 g of a light brown, fine solid (powder).

Analysis:

UV spectroscopy of the redispersed powder showed the absorption of ZnO and of the organic chromophore. The absorption edge of the modified ZnO had a much lower wavelength (approx. 330 nm) than the unmodified ZnO from comparative example 1 (approx. 380 nm)—this confirms the smaller particle size.

TEM showed, in comparative test 1, crystalline ZnO nanoparticles without surface modification and with particle size of 4 to 5 nm. The ZnO particles modified with the UV absorber had a particle size of 2 to 3 nm according to TEM.

A solid state NMR showed that there was no longer any free UV absorber. All of the UV absorber was present in bound form.

This test was performable analogously with similar results for the following chromophores:

AE ZnO: absorption edge-modified ZnO

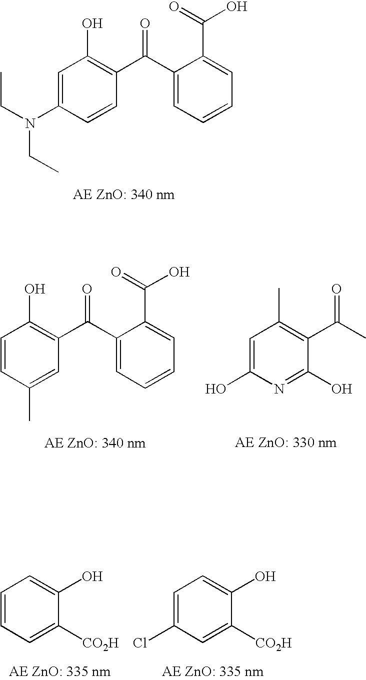

### Example 2

### ZnO and Silane Linkers

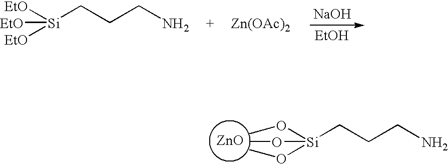

A mixture of a zinc acetate solution (1 eq, 0.03 molar ethanolic solution), sodium hydroxide solution (1 eq, 1 molar ethanolic solution) and 3-aminopropyltriethoxysilane (0.5 eq, 0.03 molar solution in ethanol) was stirred at room temperature for 24 hours. The mixture was then centrifuged, and the solid removed was washed repeatedly with methanol.

Analysis:

¹H NMR no longer shows any SiOEt groups,

TEM shows very small (from 2 to 3 nm) crystalline modified ZnO particles,

TGA (room temperature to 600° C.) shows a mass loss of approx. 40%, corresponding to the organic content.

Use of lithium hydroxide resulted in smaller particles (from 1 to 2 nm) and use of potassium hydroxide in larger particles (from 5 to 10 nm).

Concentrations and ratios of the reagents were varied in order to obtain further products.

Reactions at RT:

Zinc acetate as a 0.03 molar ethanolic solution.

NaOH as a 1 molar ethanolic solution.

LiOH as a 0.25 molar ethanolic solution.

3-aminopropyltriethoxysilane (96%, from Fluka) as a 0.03 molar methanolic solution.

3-(methacryloyloxy)propyltrimethoxysilane (97%, from Alfa Aesar) as a 0.03 molar methanolic solution.

Sol.: solution

| | Molar | | Molar | |
|---|---|---|---|---|
| Hydroxide | Zn:OH— | | Zn:Silane | Appearance of the sol. |
| (c/solb.) | ratio | Silane | ratio | (after 24 h) |
| NaOH | 1:1 | 3-Aminopropyltriethoxysilane | 1:2 | at first clear sol. |
| | | | | then turbid/sediment |
| NaOH | 1:1 | 3-Aminopropyltriethoxysilane | 1:2 | turbid/sediment |
| NaOH | 1:1 | 3-Aminopropyltriethoxysilane | 1:1 | at first clear sol. |
| | | | | then turbid/sediment |
| NaOH | 1:1 | 3-(Methacryloyloxy) | 1:2 | clear sol. |
| | | propyltrimethoxysilane | | |
| NaOH | 1:1 | 3-(Methacryloyloxy) | 1:1 | clear sol. |
| | | propyltrimethoxysilane | | |
| LiOH | 1:3 | 3-Aminopropyltriethoxysilane | 1:2 | clear sol. |
| LiOH | 1:3 | 3-Aminopropyltriethoxysilane | 1:1 | clear sol. |
| LiOH | 1:3 | 3-(Methacryloyloxy) | 1:2 | clear sol. |
| | | propyltrimethoxysilane | | |
| LiOH | 1:3 | 3-(Methacryloyloxy) | 1:1 | clear sol. |
| | | propyltrimethoxysilane | | |
| NaOH | 1:1 | 3-Aminopropyltriethoxysilane | 1:0.5 | at first clear sol. |
| | | | | then turbid/sediment |
| NaOH | 1:1 | 3-(Methacryloyloxy) | 1:0.5 | clear sol. |
| | | propyltrimethoxysilane | | |
| LiOH | 1:3 | 3-Aminopropyltriethoxysilane | 1:0.5 | clear sol. |
| LiOH | 1:3 | 3-(Methacryloyloxy) | 1:0.5 | clear sol. |
| | | propyltrimethoxysilane | | |

Reactions at 60° C.

| ZnAc | | | | | |
|---|---|---|---|---|---|
| (Concentration: | Hydroxide | Molar | | Molar | |
| % by wt. in sol. | (concentration: % by wt. | Zn:OH− | | ZnO:Si | Appearance of the |
| or molarity) | in sol. or molarity) | ratio | Silane | ratio | solution |
| 23% in MeOH | NaOH 23% in MeOH | 1:0.5 | 3- | 1:0.05 | slightly turbid/ |
| | | | (Methacrylo- | | homogeneous |
| | | | yloxy | | solution |
| | | | propyl- | | |
| | | | trimethoxy- | | |
| | | | silane | | |
| 20.5% in MeOH | NaOH 23% in MeOH | 1:1 | 3- | 1:0.5 | very fine precipitate |
| | | | (Methacrylo- | | |
| | | | yloxy | | |
| | | | propyl- | | |
| | | | trimethoxy- | | |
| | | | silane | | |
| 0.03 molar in | NaOH 1 molar in EtOH | 1:1 | 3- | 1:0.5 | clear sol. |
| EtOH | | | Aminopropyltriethoxysilane | | |
| 0.03 molar in | NaOH 1 molar in EtOH | 1:1 | 3- | 1:0.5 | clear sol. |
| EtOH | | | (Methacrylo- | | |
| | | | yloxy | | |
| | | | propyl- | | |
| | | | trimethoxy- | | |
| | | | silane | | |
| 0.03 molar EtOH | LiOH 0.25 molar EtOH | 1:3 | 3- | 1:0.5 | slight turbidity |
| | | | Aminopropyltriethoxysilane | | |
| 0.03 molar EtOH | LiOH 0.25 molar in EtOH | 1:3 | 3- | 1:0.5 | slight turbidity |
| | | | (Methacrylo- | | |
| | | | yloxy)propyltri- | | |
| | | | methoxy- | | |
| | | | silane | | |

### Example 3

Silane-Cinnamic Acid Chromophore

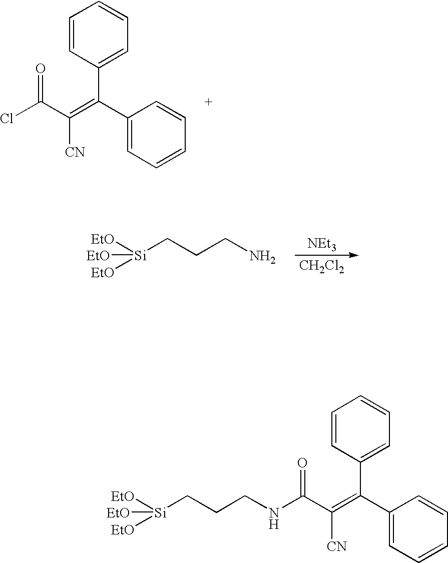

A mixture of triethylamine (1.5 eq) and 3-aminopropyltriethoxysilane (1 eq) was dissolved in dichloromethane and admixed with a cinnamyl chloride solution (1 eq). The mixture was stirred at room temperature for 24 h. Subsequently, the product solution was repeatedly washed with water and dried, and the solvent was drawn off.

¹H-NMR confirmed the desired structure: δ_{H} (CDCl₃) 0.70 (2H, t, CH₂Si), 1.25 (9H, t, 3×CH₃), 1.72 (2H, m, CH₂CH₂Si), 3.39 (2H, q, CH₂NH), 3.85 (6H, q, 3×OCH₂), 6.10 (1H, s, NH), 6.48 (1H, d, CH═C), 7.3-7.4 (3H, m, Ar), 7.45-7.55 (2H, m, Ar) and 7.62 (1H, d, CH═C)

### Example 4

Silane-Cyanoacrylate Chromophore

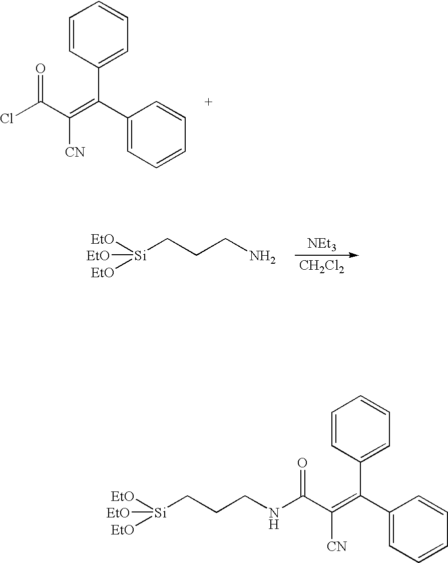

A mixture of triethylamine (1.5 eq) and 3-aminopropyltriethoxysilane (1 eq) was dissolved in dichloromethane and admixed with a 3,3-diphenyl-2-cyanoacryloyl chloride solution (1 eq). The mixture was stirred at room temperature for 24 h. Subsequently, the product solution was repeatedly washed with water and dried, and the solvent was drawn off.

¹H-NMR confirmed the desired structure: δ_{H} (CDCl₃) 0.55 (2H, t, CH₂Si), 1.35 (9H, t, 3×CH₃), 1.50 (2H, m, CH₂CH₂Si), 3.20 (8H, m, 3×OCH₂+CH₂N), 7.0-7.5 (10H, m, Ar) and 11.8 (1H, q, NH)

### Example 5

### ZnO with Cinnamic Acid-Silane

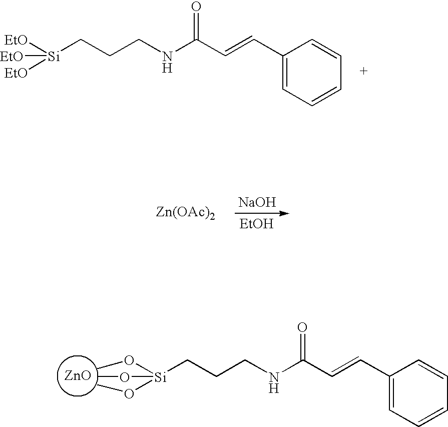

A mixture of zinc acetate (1 eq. 0.03 molar ethanolic solution), sodium hydroxide (1 eq., 1 molar ethanolic solution) and the cinnamate shown above (0.5 eq, 0.155 molar ethanolic solution) was stirred at room temperature for 24 hours. Thereafter, the solvent was drawn off in order to obtain the particles.

Analysis:

TEM shows modified crystalline ZnO with a particle size of 2 to 3 nm.

The UV-vis spectrum shows the cinnamic acid absorption at λₘₐₓ 270 nm.

### Example 6

### ZnO with Cyanoacrylamide-Silane

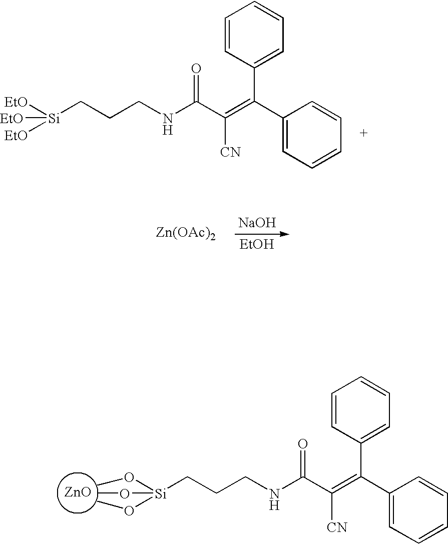

A mixture of zinc acetate (1 eq, 0.03 molar ethanolic solution), sodium hydroxide (1 eq, 1 molar ethanolic solution) and cyanoacrylamide-silane (0.5 eq, 0.155 molar ethanolic solution) was stirred at room temperature for 24 hours. Thereafter, the solvent was drawn off in order to obtain the particles.

Analysis:

TGA (room temperature to 600° C.) shows a mass loss of approx. 40%, corresponding to the organic content.

TEM shows modified crystalline ZnO with a particle size of 2 to 3 nm.

The UV-vis spectrum shows the cynanoacrylate absorption at λₘₐₓ 295 nm.

### Example 7

TiO₂ with Chromophore in Ethanol

General Method:

Distilled water (0.7-14 eq) was added to an ethanolic solution of a UV-absorbing chromophore (0.1-1 eq). Titanium tetraisopropoxide (1 eq) was added dropwise to this solution at room temperature with stirring. After reaction at room temperature for 1 hour, the solution was concentrated to dryness in order to obtain the particles. The resulting product was redispersed in ethanol.

The solution remained stable for several months without the particles growing further.

### Experiment Example

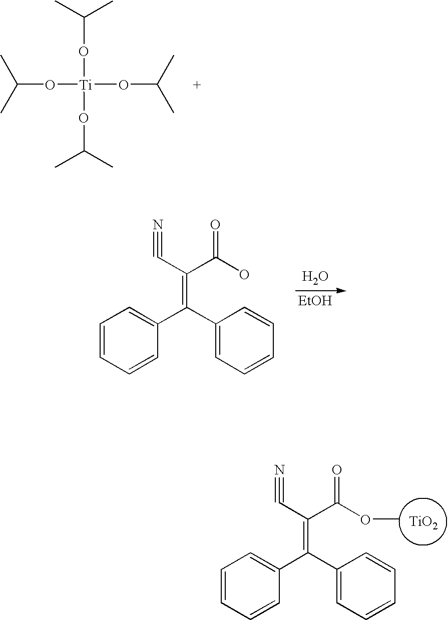

59 mg (0.24 mmol) of 3,3-diphenyl-2-cyanoacrylic acid were dissolved in 10 ml of ethanol. 21.4 μl (1.19 mmol) of distilled water were added. Subsequently, 100 μl (0.34 mmol) of titanium tetraisopropoxide are added to this solution with stirring. After reaction at room temperature for 1 h, the product solution was concentrated to dryness at RT and 0-10 mbar on a rotary evaporator.

The same reaction was performed in different molar ratios of titanium tetraisopropoxide:water:chromophore of 1:0.7:0.1 to 1:14:1.

The following chromophores were reacted analogously:

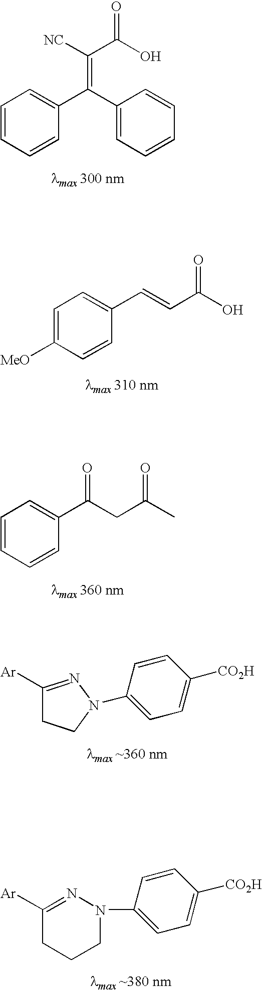

Analysis:

UV spectra in ethanol: absorption of the TiO₂ and of the chromophore are both observed. Particle size determination by laser diffraction: particle size of 1 to 6 nm.

1. A particle P which is obtainable by the reaction of compounds V which can form inorganic nanoparticles X with organic molecules M which comprise functional groups Z, where the molecules M and the compounds V are present together during the formation process of the particles P.

2. The particle according to claim 1, wherein the particle P has a particle size of from 1 nm to 50 nm.

3. The particle according to claim 1 or 2, wherein the inorganic nanoparticles X comprise metal oxides.

4. The particle according to claim 3, wherein the nanoparticles X comprise metal oxides of the general formula AₓO_{y},
where
x is a number from the range from 1 to 3 and
y is a number from the range from 1 to 5 and
A is a metal
or mixtures thereof.

5. The particle according to claim 4, where the metal oxides are ZnO, TiO₂, ZrO₂, CeO2, Ce₂O₃, SnO₂, SnO, Al₂O₃, SiO₂, or Fe₂O₃ or mixtures of these metal oxides.

6. The particle according to claims 1 to 5, where the particle P obeys the symbolic formula X-M and the organic molecules M are located essentially at the surface of the particle P.

7. The particle according to claim 6, where the organic molecules M obey the formula Y′—Z and Y′ is a chemical structural unit (linker) via which the organic molecules M interact with the inorganic nanoparticles X.

8. The particle according to claim 6, where the organic molecules M obey the formula Y—Z, Y is a chemical structural unit (linker) via which the organic molecules interact with the inorganic nanoparticles X and Y is formed after a chemical reaction from Y′.

9. The particle according to claim 7 or 8, corresponding to the symbolic general formulae (I) or (II):
X—Y′—Z (I)
X—Y—Z (II),
where —Y′—or —Y— are given by 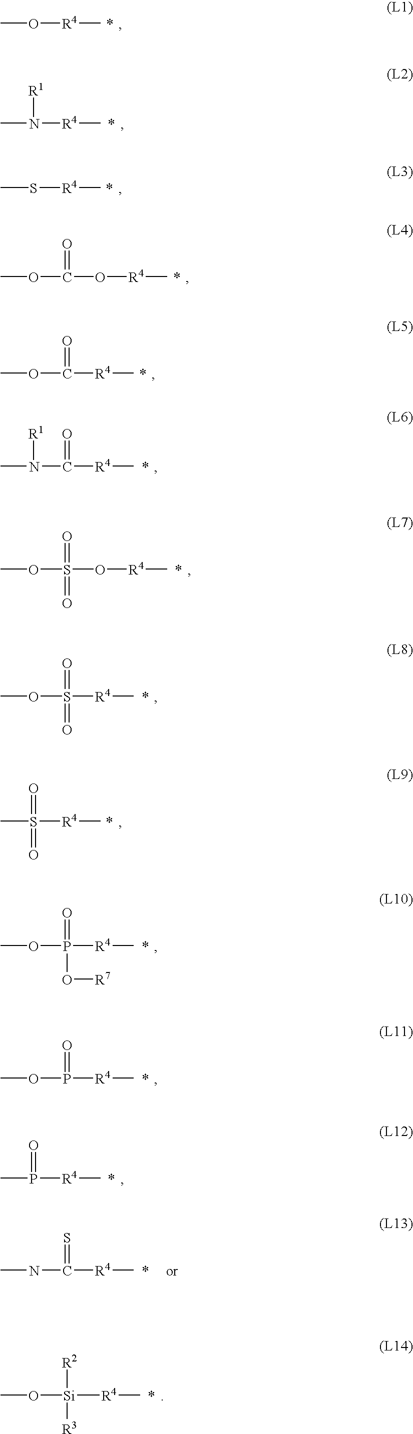
and “*” is the bond to the functional group Z,
where
R¹ is H, C₁-C₂₀-alkyl, aryl, arylalkyl, heterocycles, C₁-C₂₀-alkylcarbonyl,
R², R³ independently of one another are O, C₁-C₂₀-alkoxy, C₁-C₂₀-alkyl, aryl, arylalkyl, heterocycles,
R⁴ is a chemical single bond, O, C₁-C₂₀-alkylene, C₁-C₂₀-alkylene-R⁵,
R⁵ is O, N, S, N(R⁶)—C═O, N—CO₂, O₂C, CO₂, O₂CN, OCO₂, 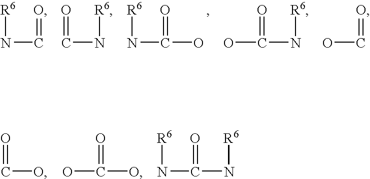
R⁶ is H, C₁-C₂₀-alkyl,
R⁷ is H, metal cations, and
where the substituents R¹ to R⁴ and/or R⁶ may in each case be interrupted at any desired position by one or more heteroatoms, where the number of these heteroatoms is not more than 10, preferably not more than 8, very particularly preferably not more than 5 and in particular not more than 3, and/or can in each case be substituted at any desired position, but not more than five times, preferably not more than four times and particularly preferably not more than three times, by C₁-C₂₀-alkyl, C₁-C₂₀-alkoxy, aryl, aryloxy, heterocycles, heteroatoms or halogen, where these can likewise be substituted a maximum of twice, preferably a maximum of once, with the specified groups.

10. The particle according to claims 1 to 9, wherein the organic molecule M has a molecular weight of less than 800 g/mol.

11. The particle according to claims 7 to 10, corresponding to the general formulae X—Y′—Z or X—Y—Z where —Z is 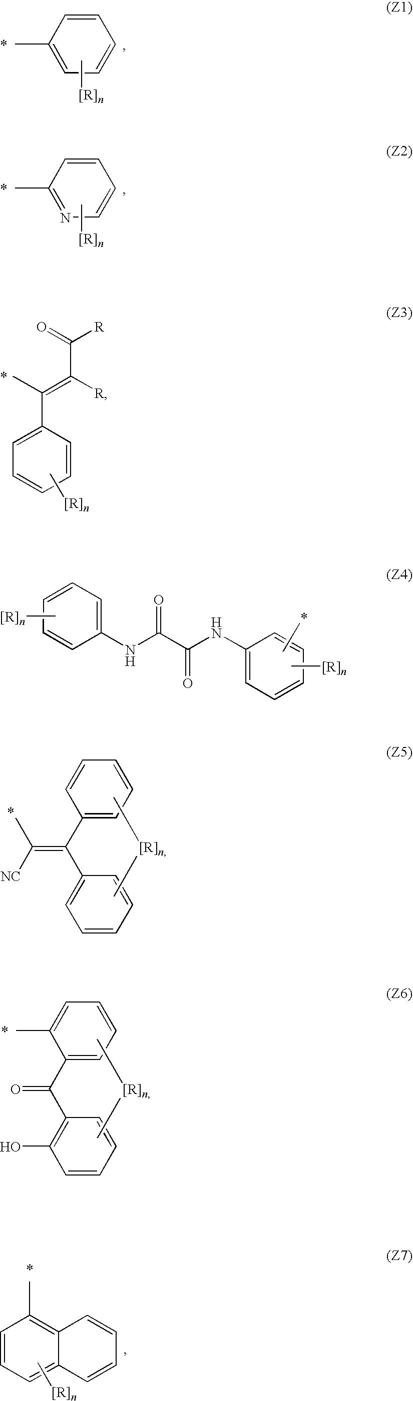 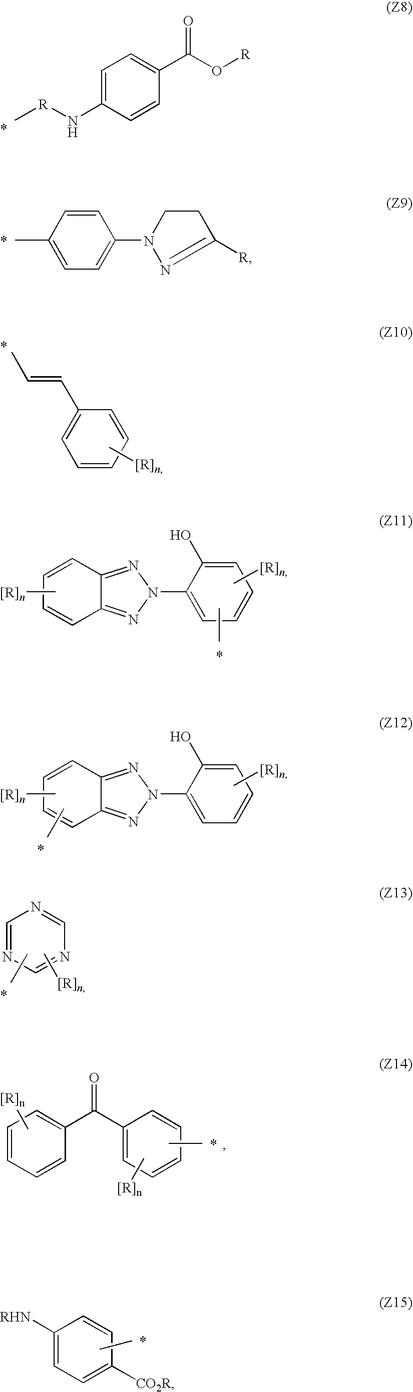 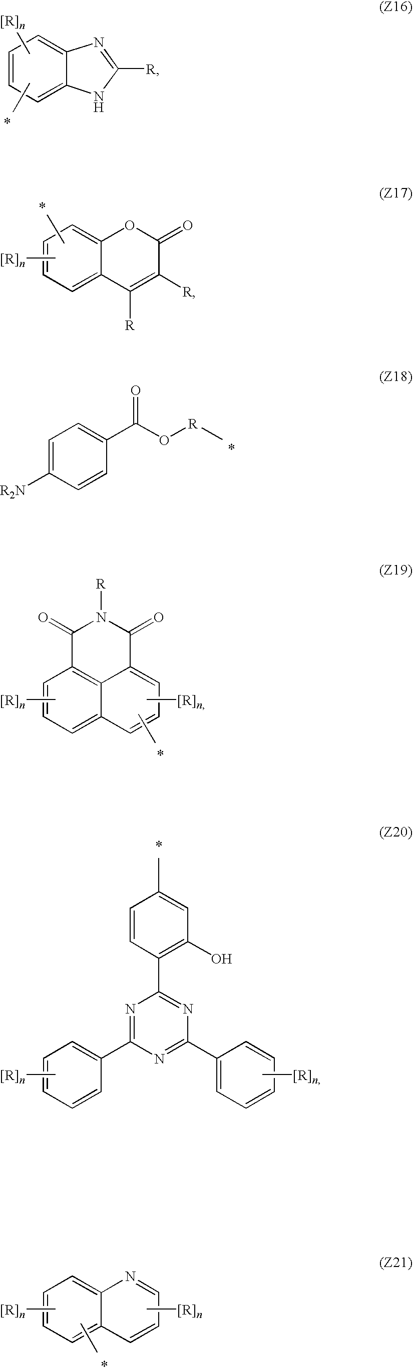
(*symbolizes the bonding site to the linker Y or Y′)
where
R is halogen, hydroxy, phenyl, C₁-C₂₀-alkyl, hydroxyphenyl, C₁-C₂₀-alkoxy, aryl, aryloxy, amino, mono- or dialkylamino, nitrile, carboxylate, ester, thiol, sulfoxides, sulfonic acid, acyl, formyl, carbonyloxyalkyl, carbonylaminoalkyl
n is an integer from the range from 0 to 4,
and the n substituents R, independently of one another, may be identical or different, and where the substituent R can be interrupted at any desired position by one or more heteroatoms, where the number of these heteroatoms is not more than 10, preferably not more than 8, very particularly preferably not more than 5 and in particular not more than 3, and/or can in each case be substituted at any desired position, but not more than five times, preferably not more than four times and particularly preferably not more than three times, by C₁-C₂₀-alkyl, C₁-C₂₀-alkoxy, aryl, aryloxy, heterocycles, heteroatoms or halogen, where these can likewise be substituted a maximum of twice, preferably a maximum of once, with the specified groups.

12. The particle according to claims 1 to 11, wherein the particle P absorbs electromagnetic radiation in the wavelength range from 200 to 600 nm.

13. The particle according to claim 12, wherein the absorption spectrum of the particle P has an absorption maximum in the wavelength range from 200 to 600 nm.

14. A powder comprising particles according to claims 1 to 13.

15. A liquid formulation comprising particles according to claims 1 to 13.

16. A method for the preparation of particles according to claims 1 to 13, comprising the following steps:
(a) preparation of the compound V optionally dissolved in a solvent of the organic molecules M optionally dissolved in a solvent,
(b) mixing of the compounds V with the organic molecules M, optionally in a solvent,
(c) reaction of the mixture from (b), optionally with addition of further substances or of further organic molecules M, optionally under the reaction conditions which would lead to the formation of nanoparticles X from compounds V, to give inventive particles P,
(d) optionally isolation of the particles P,
(e) optionally purification and work-up of the particles P,
(f) optionally further modification of the particles P,
(g) optionally redispersion of the particles P.

17. The method according to claim 16, wherein the compounds V and the organic molecules are dissolved in a solvent in step (a) and mixed in dissolved form in step (b).

18. The method according to claim 16 or 17, wherein the further substances added in step (c) are initiators or catalysts for the formation of the inorganic nanoparticles X.

19. The method according to claims 16 to 18, wherein, in step (c), further organic molecules M are added.

20. The method according to claims 16 to 19, wherein the inorganic nanoparticles X are metal oxides.

21. The method according to claim 20, wherein the metal oxides X are ZnO, TiO₂, ZrO₂, CeO₂, Ce₂O₃, SnO₂, SnO, Al₂O₃, SiO₂ or Fe₂O₃ or mixtures of these metal oxides.

22. A method of controlling particle size, wherein particles are prepared by a method according to claims 16 to 21.

23. A method of suppressing the photocatalytic activity of inorganic nanoparticles X, wherein particles according to claims 1 to 13 are prepared, with UV-absorbers being used as organic molecules M.

24. A method of stabilizing UV-absorbers, wherein the UV-absorbers are introduced as organic molecules M in particles P according to claims 1 to 13.

25. A method of stabilizing polymers against the effect of light, free radicals or heat, wherein mixtures comprising particles according to claims 1 to 13 are added to the polymers in an amount which suffices to stabilize the polymers.

26. A method of stabilizing polymers against the effect of UV light, wherein mixtures comprising particles according to claim 12 or 13 are added to the polymers in an amount which suffices to stabilize the polymers.

27. The method of stabilizing polymers according to claim 25 or 26, wherein the mixtures comprise further stabilizers besides the particles.

28. A method of stabilizing polymers according to claim 27, wherein the further stabilizers are UV-absorbers, antioxidants, sterically hindered amines, nickel compounds, metal deactivators, phosphites, phosphonites, hydroxylamines, nitrones, amine oxides, benzofuranones, indolinones, thiosynergists, peroxide-destroying compounds or basic costabilizers.

29. The use of particles P according to claim 12 or 13 for stabilizing polymers against the effect of light.

30. The use of particles according to claim 12 or 13 as UV-absorbers in cosmetic applications.

31. A method for stabilizing polymers against the effect of light, free radicals or heat, wherein nanoparticles with organic, light-absorbing compounds attached to their surfaces are added to the polymer.

32. The use of nanoparticles with organic, light-absorbing compounds attached to their surfaces for stabilizing polymers against the effect of light, free radicals or heat.
